(19) United States
(12) Patent Application Publication
(10) Pub. No.: US 2013/0050635 A1
(43) Pub. Date: Feb. 28, 2013

(54) Elastically collapsible goggles

(71) Applicant: Chun-Chih Cheng, Tainan City (TW)

(72) Inventor: Chun-Chih Cheng, Tainan City (TW)

(21) Appl. No.: 13/199,184

(22) Filed: Aug. 23, 2011

(51) Int. Cl. G02C 5/16

(52) U.S. Cl. 351/114

(57) ABSTRACT

A pair of elastically collapsible goggles in the present invention is mainly composed of a lens rim and two temples. The two temples respectively have a front section integrally formed with an elastic portion to enable the temples to be automatically and elastically collapsed and laid on the inner side of the lens rim when the goggles are not used. Thus, the goggles of this invention can conveniently be elastically collapsed, practical in use.

### BACKGROUND OF THE INVENTION

1. Field of the Invention

This invention relates to elastically collapsible goggles having a front section of each temple integrally formed with an elastic portion for facilitating the temples to be automatically collapsed and offering elasticity to let the eyeglasses worn comfortably.

2. Description of the Prior Art

A pair of conventional eyeglasses is composed of a lens rim assembled thereon with a pair of lenses, a pair of pivotal members respectively secured at two opposite sides of the lens rim and a pair of temples respectively and pivotally connected with the pivotal members of the lens rim. Substantially, the only function of the temples of the conventional eyeglasses is to be collapsed and stretched open. If the conventional eyeglasses are hit by external force when the wearer plays balls or takes exercises, the pivotal portion of the temple and the lens rim will be excessively stretched open to damage the eyeglasses.

In addition, the temples of the conventional eyeglasses are always in a slack state no matter whether they are stretched open or collapsed; therefore, the temples are unable to be elastically clamped on a pocket in front of the chest and apt to drop down when the wearer bends his waist downward.

Although another conventional eyeglasses, as disclosed in a U.S. Pat. No. 7,490,933 and titled “Hingeless eyeglasses; especially safety glasses”, can be collapsed automatically, yet the lenses of the eyeglasses are assembled on the integrally-formed lens rim by mutual engagement so they are unable to be closely and firmly combined with the lens rim. As a result, the lenses are likely to disengage from the lens rim and may cause danger to the wearer. Further, since the curved lenses are combined with the lens rim by mutual engagement, the arcuate surface of the lenses may lose fidelity and disable the wearer to see things clearly. Furthermore, it is difficult to integrally make a lens rim by injection molding, resulting in increase of unqualified percentage and processing cost.

### SUMMARY OF THE INVENTION

The objective of this invention is to offer a pair of goggles provided with elastic temples able to be elastically collapsed automatically.

The goggles in the present invention include a lens rim having two sides respectively provided with a combining portion and its center mounted with a bridge having two sides respectively disposed with a lens. Two temples integrally made of plastic are respectively combined on the opposite combining portions of the lens rim, respectively having a front section provided with a thin-and-flat linking member and an elastic portion that is formed with parallel included angles with certain elastically.

### BRIEF DESCRIPTION OF DRAWINGS

This invention will be better understood by referring to the accompanying drawings, wherein:

FIG. 1 is an exploded perspective view of the elastically collapsible goggles in the present invention;

FIG. 2 is a perspective view of the elastically collapsible goggles in the present invention;

FIG. 3 is a partial schematic view of the goggles in the present invention, illustrating that the temple is collapsed; and

FIG. 4 is a partial schematic view of the goggles in the present invention, illustrating that the temple is stretched open.

### DETAILED DESCRIPTION OF THE PREFERRED EMBODIMENT

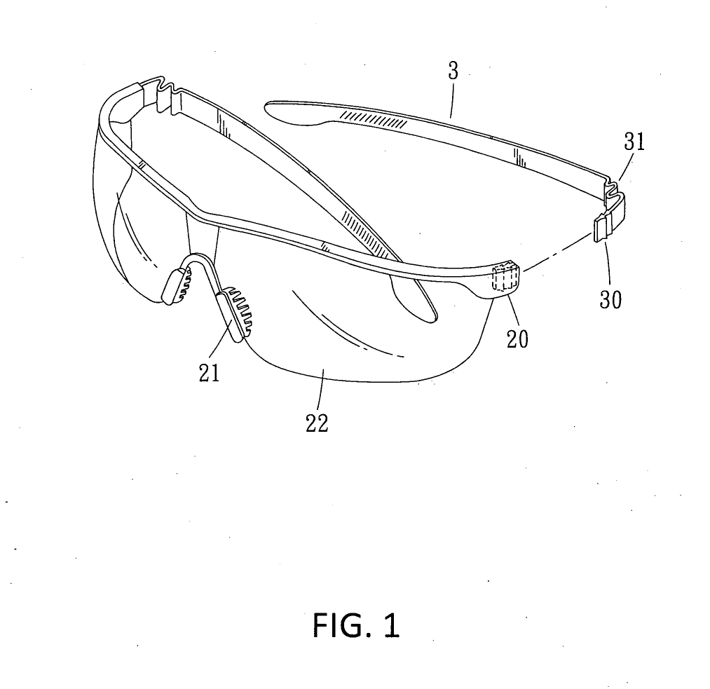

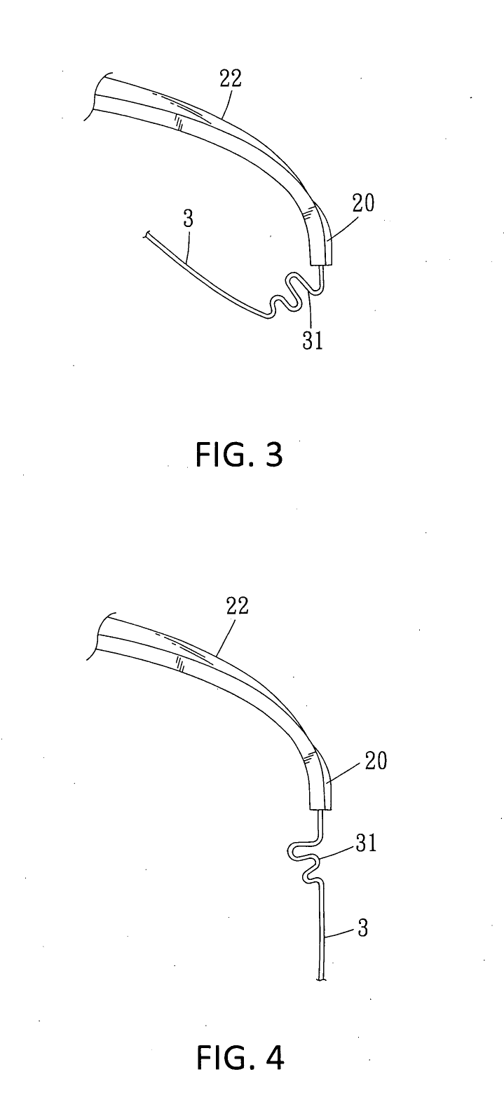

A preferred embodiment of elastically collapsible goggles in the present invention, as shown in FIGS. 1-4, are mainly composed of a lens rim 2 and two temples 3. The lens rim 2 has two sides respectively formed with a combining portion 20 and its center provided with a bridge 21 having two sides respectively set with a lens 22. The two temples 3 are respectively secured on the combining portions 20 of the lens rim 2, respectively having a front section provided with a thin-and-flat linking member 30 formed integrally and an elastic portion 31, which is designed to be approximately a parallel [symbol] shaped body.

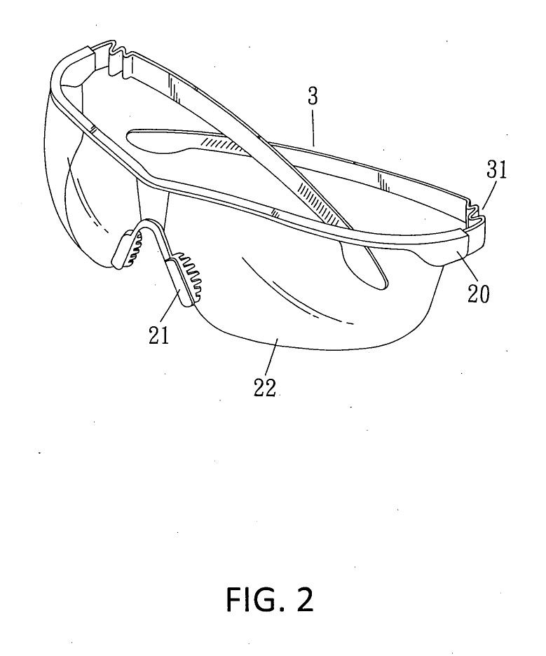

In assembling, when the linking members 30 of the temples 3 and the combining portions 20 of the lens rim 2 are combined together to form a pair of eyeglasses, the linking members 30 and the combining portions 20 are combined in a mode of interference fit so they are impossible to be disengaged from each other. The temples 3 can conveniently be collapsed and laid on the inner side of the lens rim 2 via the elastic force of the elastic portions 31, as shown in FIG. 2, saving storage space. To wear the goggles, it only needs to pull outward the temples 3 and put the goggles on and at this time, the temples 3 can elastically and closely contact with a wearer's face by action of the elastic portions 31.

As can be understood from the above description, this invention has the following advantages.

1. The elastic portion 31 of each temple 3 is formed integrally and designed to be bent elastically; therefore, when collapsed, the temples 3 can be positioned comparatively close to the lens rim 2, thus lessening a storage space.

2. The elastic portions 31 of the temples 3 can be designed to be a [symbol] shape, a [symbol] shape or a [symbol] shape to offer elastic contact for enabling a wearer to wear the goggles with comfort.

3. The specially-designed elastic temple 3 of this invention is formed with an allowance, which permits the elastic temples 3 to be elastically stretched open excessively; therefore, even if the temples 3 are excessively stretched open when the wearer plays balls or takes exercises, the temples 3 will not be damaged, able to content the wearers.

4. Due to function of the elastic portion 31 of the temple 3, the critical sides of the included angles of the elastic portions 31 can function to produce elasticity needed by the temples 3 so that the temples 3 can be elastically stretched open and positioned stably at the open condition and also elastically collapsed and positioned stably at the collapsed condition, completely eliminating the drawback of the conventional temples that are always in a slack state whether or not they are used.

5. The specially-designed temples 3 of this invention are simple in structure and able to produce various efficacies needed by the wearer, facilitating manufacture and increasing only a little more manufacturing cost and selling price.

While the preferred embodiment of the invention has been described above, it will be recognized and understood that various modifications may be made therein and the appended claims are intended to cover all such modifications that may fall within the spirit and scope of the invention.

What is claimed is:

1. Elastically collapsible goggles comprising:
a lens rim having two sides respectively provided with a combining portion, said lens rim having a center fixed with a bridge, said bridge having two sides respectively assembled with a lens;
two temples respectively combined with said combining portions of said lens rim, said temples integrally made of plastic, each said temple having a front section disposed with a thin-and-flat linking member and an elastic portion, said elastic portion formed with parallel included angles with certain elasticity; and
Foresaid components combined together to form a pair of goggles with elastic temples able to be elastically collapsed automatically.

2. Elastically collapsible goggles as claimed in claim 1, wherein said elastic portion of each said temple is designed to be a [symbol] shape.

3. Elastically collapsible goggles as claimed in claim 1, wherein said elastic portion of each said temple is designed to be a [symbol] shape.

4. Elastically collapsible goggles as claimed in claim 1, wherein said elastic portion of each said temple is designed to be a [symbol] shape.

5. Elastically collapsible goggles as claimed in claim 1, wherein said combining portion at two sides of said lens rim and said linking member at a front end of each said temple are combined in a mode of interference fit, so they are not easy to be disengaged from each other after being combined together.
